(19) United States
(12) Patent Application Publication
(10) Pub. No.: US 2010/0043408 A1
(43) Pub. Date: Feb. 25, 2010

(54) METHOD FOR THE CALIBRATION AND MANAGEMENT OF AN EXHAUST LINE COMPRISING A PARTICLE FILTER

(75) Inventors: Patrick Girot, Salon De Provence (FR); Francisco Jose Carranza, Brussels (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN CTR DE RCH ET D'ETUDES EUROPEEN, Courbevoie (FR)

(21) Appl. No.: 12/515,334

(22) PCT Filed: Nov. 13, 2007
(86) PCT No.: PCT/FR2007/052331

§ 371 Date: May 18, 2009

(30) Foreign Application Priority Data
Nov. 17, 2006 (FR) 0654961

(51) Int. Cl. F02D 43/00; F01N 3/023; F01N 3/035

(52) U.S. Cl. 60/287; 60/295; 60/297

(57) ABSTRACT

The invention relates to a method for the calibration and/or management of an exhaust line of a motor vehicle comprising a particle filter (X), said method comprising an initial step of measuring, over a representative population of the filter, the increase in the loss of load generated by a limited load of soot particles present in a filter, that is the threshold for the triggering of a filter regeneration phase; a step of measuring, in the absence of soot particles, the loss of specific load of the filter (X); and a step of determining, on the basis of the values obtained in steps a) and b), a limited value for the loss of load, that is the threshold for the triggering of a regeneration phase. The invention also relates to a system for managing an exhaust line comprising means for implementing said method.

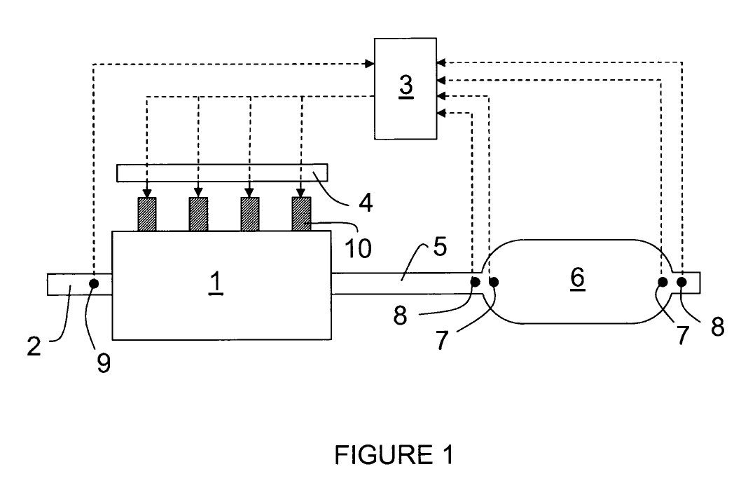

The invention relates to the field of particulate filters, especially those used in an engine exhaust line for eliminating the soot particles produced by the combustion of a fuel, for example diesel, in an internal combustion engine.

The present invention relates more particularly to a method for the calibration and control of an exhaust line that includes such a particulate filter, enabling the operation thereof to be optimized.

It is well known that the presence of a particulate filter in an exhaust line of an internal combustion engine, in particular a diesel engine, enables the amount of particulates, dust and other soot particles emitted into the atmosphere to be considerably reduced and thus enables the pollution control standards to be met.

Structures for filtering the soot particles contained in the exhaust gases of an internal combustion engine are well known in the prior art. These structures usually have a honeycomb structure, one of the faces of the structure allowing entry of the exhaust gases to be filtered and the other face for discharging the filtered exhaust gases. Between the entry and discharge faces, the structure comprises an assembly of adjacent ducts or channels of mutually parallel axes, separated by porous filtration walls, which ducts are closed off at one or other of their ends so as to define outlet chambers opening onto the entry face and outlet chambers opening onto the discharge face. For proper gastightness, the peripheral part of the structure is usually surrounded by a cement coating. The channels are alternately closed off in an order such that the exhaust gases, in the course of their passage through the honeycomb body, are forced to pass through the sidewalls of the inlet channels before rejoining the outlet channels. In this way, the particulates or soot particles are deposited on the porous walls of the filter body and accumulate thereon. Usually, the filter bodies are made of a porous ceramic, for example one based on cordierite or silicon carbide.

During operation of the internal combustion engine, the particulate filter is progressively loaded with unburnt hydrocarbons, the accumulation of which ends up with the performance of the filter and that of the engine being degraded. This accumulation is manifested by an increase in the pressure drop, i.e. the pressure difference between the upstream end and the downstream end of the filter in the engine exhaust line. For correct operation of the engine, it therefore turns out to be necessary for the filter to be periodically “cleaned” in situ, which operation is carried out by burning off the particles inside the filter. As is known, during its operation, the particulate filter is thus subjected to a succession of filtration (soot accumulation) and regeneration (soot elimination) phases. During the filtration phases, the soot particles emitted by the engine are retained, being deposited inside the filter. During the regeneration phases, the soot particles are burnt off inside the filter in order to restore its filtering properties and to reduce the pressure drop thereof.

However, if the regeneration operations are poorly controlled, for example triggered too late, the porous structure may then be subjected to extremely intense thermomechanical stresses that may result in cracks liable, over the duration, to result in a severe loss of filtration capacity of the unit, or even its complete deactivation.

More broadly, by properly controlling the regeneration it is possible in particular to avoid the following problems:
an underestimate of the actual level of soot loading of the particulate filter: there is therefore a risk of the filter, or possibly the catalyst when the filter incorporates a catalytic component, deteriorating. Since the regeneration is too late, the combustion of the excessively large number of accumulated soot particles in certain parts of the filter results in combustion runaway at very hot spots or zones and in the appearance of cracks, in extreme cases, even in destruction of the filter;
an overestimate of the actual level of soot loading of the particulate filter: the consequence is then too high a regeneration frequency and consequently a high overconsumption of fuel and, most particularly, the premature damage of the engine caused by substantial oil dilution due to the increase in post-injection times.

To try to solve these problems, various control methods have already been described.

According to a first control mode, which is the simplest possible, the regeneration operation may be triggered at the end of a certain time interval or after a certain distance traveled, without taking into account the actual soot load of the filter amassed over the course of time. By applying such a principle, in the event of a nonconforming operation of the engine causing an abnormal increase in particulate emissions, the risk of damaging the filter becomes considerable, since the regenerations will be carried out with an amount of soot greater than the limit mass of soot.

According to a more complex control mode, the regeneration may be triggered when the filter reaches a certain soot loading that is determined according to the increase in the pressure drop brought about on the line by the filter.

Thus, several methods and devices have been developed for optimizing the regeneration operations, which use an estimate of the actual loading of the filter. This estimate of the actual soot loading is usually deduced from the measurement of the pressure difference between the upstream side and the downstream side of the filter.

Among these, mention may be made of the application FR 2 774 421 which proposes a method of controlling the regeneration that relies on a limit threshold value of the pressure drop in order to trigger the regeneration phase. Application FR 2 829 798 proposes a more elaborate system that includes a step of determining the state of a catalytic filter, either by a pressure drop estimate via a model or by a pressure drop measurement, the choice between measurement and estimate depending on the running conditions.

Also known, from application EP 587 146, is a method of regenerating a particulate filter that includes control means based on a measurement of the pressure drop. According to that document, the regeneration of the filter is triggered if the loading of the filter exceeds a predetermined value. This loading is deduced from the pressure difference between the inlet side and the outlet side of the filter and from a characteristic quantity of the volume flow rate of the gases passing through the filter.

However, all the methods described hitherto do not take into account the possible variations in the filtration properties that exist from one filter to another, even if they are of the same nature, i.e. those obtained on the basis of the same materials and by a similar manufacturing process.

In particular, in all the configurations described hitherto, the fact remains that the methods of controlling the regeneration phases are always with reference to predetermined threshold values of the pressure drop beyond which the regeneration starts and optionally terminates. These threshold values are usually described as being extrapolated from a model or as being determined in advance and averaged over a representative population of filters.

It may therefore be seen that solving the specific problem of controlling the filter regeneration phases in an exhaust line involves complex and expensive control systems, the most advanced methods requiring for example an increasing amount of data to be taken into account for characterizing the state of loading of the filter (such as pressure drop, engine speed, temperature, flow rate of gas passing through the engine, etc.).

In parallel with this complexification, and again with a view to controlling the regeneration phases more effectively, automobile manufacturers now impose increasingly strict specifications as regards particulate filters. These specifications relate in particular to the characteristics of the filter in terms of filtration and pressure drop. In particular, the pressure drop dispersion, i.e. its variation from one filter to another, must be as low as possible around a target value.

A first object of the present invention is to remedy the abovementioned problems of controlling the recycling phases by providing a calibration and control method specific to each filter, which furthermore makes it possible to optimize, make secure and simplify the operations specific to regeneration compared with the methods described in the prior art. Such improved control makes it possible in the end to increase the lifetime of the filter in the exhaust line.

A second object of the present invention is to provide a simple and inexpensive method for qualifying filters on the basis of specifications that are more flexible than at the present time. In particular, by applying the present invention, it becomes possible to qualify a population of filters, the variations, from one filter to another, in the resulting pressure drop on an exhaust line are relatively large, without correspondingly increasing the risks of the engine deteriorating or of the filter being damaged because the regeneration phase is triggered too early or too late.

More precisely, the present invention relates to a method for the calibration and/or control of an exhaust line of a motor vehicle that includes a particulate filter X, said method comprising the following steps:
a) an initial step, on a population representative of said filter, of measuring the increase in pressure drop (ΔP_{MSL})_{Q} as a function of the flow rate Q of the exhaust gases passing through said filter, (ΔP_{MSL})_{Q} being associated with a limit loading of soot particles present in a filter, i.e. a threshold for triggering a filter regeneration phase during operation of the engine;
b) a step of measuring the specific pressure drop (ΔP_{(x),soot-free})_{Q} of said filter X as a function of the flow rate Q of gases passing through the filter in the absence of soot particles; and
c) a step of determining a pressure drop limit value (ΔP_{(x),lim})_{Q}, i.e. a threshold for triggering a regeneration phase, on the basis of the values obtained from steps a) and b), said limit value being characteristic of said filter and obtained, for example, by the equation:

(ΔP_{(x),lim})_{Q}=(ΔP_{(x),soot-free})_{Q}+(ΔP_{MSL})_{Q}.

The threshold pressure drop value (ΔP_{(x),lim})_{Q} typically corresponds to a pressure drop caused by a soot loading supported by the filter X and specific thereto, beyond which there is a high risk of severe regeneration, which may potentially result in irreversible degradation of the filter.

Unlike in the prior art, this pressure drop limit value is not predetermined (for example from measurements carried out on a representative family of filters) but, according to the invention, is specific to the filter X on which the present method has been implemented.

According to the invention, (ΔP_{MSL})_{Q} corresponds to the specific contribution to the pressure drop of the sum of the soot particles present in the pores and on the internal walls of the filter at the threshold for triggering a regeneration phase. This value is for example determined beforehand during a measurement campaign carried out on a representative population of filters.

For example, a series of at least ten clean filters, i.e. filters containing no soot or residues, may be used to measure, as a function of the flow rate of gases passing through the filters, an average value of the pressure drop caused in an exhaust line by the porous structure in the absence of any particulate. Preferably, the pressure drop measurements are carried out on a test bed configured so as to correspond approximately to the technical data of the exhaust line of the vehicle incorporating said filter.

It is also possible to determine, on this same series of filters, as a function of the gas flow rate, an average value of the pressure drop caused by a filter loaded with its limit mass of soot, i.e. in such a way that a regeneration phase results in its irreversible degradation. What is thus obtained, as a function of the flow rate Q, is a term (ΔP_{MSL})_{Q} averaged over the representative sample of the filters, by the difference between the previously obtained pressure drop values of the filters loaded with their limit mass of soot and the pressure drop caused by these same filters when they are clean.

Surprisingly, the studies carried out by the Applicant have shown that the variations in the term (ΔP_{MSL})_{Q} thus determined were relatively small from one filter to another within a filter population, provided that their manufacturing conditions are substantially the same.

For example, the operating method for determining the limit mass of soot may be as follows:

A population of new filters from at least ten filters is subjected in succession to the following steps:

Firstly, each filter is mounted with its canning on an engine test bed equipped with a pressure drop measurement device so as to reproduce an exhaust line, ideally corresponding to that with which the vehicle having the filter format thus characterized will be equipped.

Secondly, the engine, for example of the diesel injection 2-liter PSA DW10A type, is operated at full power at 4000 rpm for 30 minutes so as to thermally stabilize the filters mounted as described above, i.e. with their canning. The filters are then removed and weighed with their canning in order to determine an initial mass. The filters are then put back onto the engine test bed before being subjected for different durations at an engine operation running at 3000 rpm for a torque of 50 Nm so as to be loaded with different masses of soot. The numbered filters are then weighed and the mass of soot determined for each filter by the difference between the mass obtained and the initial mass.

The filters thus loaded are put back on the line in order to undergo a severe regeneration defined as follows: after stabilization at an engine speed of 1700 rpm for a torque of 95 Nm for 2 minutes, a post-injection is carried out with 70° of phase shift for a post-injection volume of 18 mm³/cycle. Once soot combustion has been initiated, more precisely when the pressure drop decreases for at least 4 seconds, the engine speed is reduced to 1050 rpm for a torque of 40 Nm for 5 minutes so as to accelerate the soot combustion. The filter is then subjected to an engine speed of 4000 rpm for 30 minutes so as to eliminate the remaining soot particles.

The filters thus regenerated are inspected after being cut up so as to reveal the possible presence of cracks visible to the naked eye. On all the filters, it is thus possible to determine a limit mass of soot, the threshold at which cracks appear.

In general, the limit loadings of soot particles are dependent on the intrinsic thermomechanical strength of the filters and therefore mainly dependent on the intrinsic characteristics of the filter, in particular the nature of the material constituting its filtering walls and its microstructure (volume of open porosity, pore size distribution, thermal conductivity, thermal expansion coefficient, modulus of rupture, elastic modulus, etc.) without it being possible at the present time for this dependency relationship to be precisely modeled.

Preferably, steps b) and c) are carried out on the filter (X) when the latter is fitted in the exhaust line of the vehicle.

For example, (ΔP_{(x),soot-free})_{Q} is determined from various operating points of the engine, in particular from the measured or estimated exhaust gas flow rate for each of the operating points.

The value (ΔP_{(x),soot-free})_{Q} may be determined by applying a pressure drop extrapolation model, for example of the quadratic type: (Δ_{P(x),soot-free})_{Q}=aQ²+bQ+c, where a, b and c are coefficients that can be typically determined by a least-squares method.

According to one possible embodiment, steps b) and c) are carried out on a fresh filter, for example on leaving the vehicle manufacturing plant.

According to another embodiment, steps b) and c) are carried out at regular intervals on a used but soot-free filter, for example after a prolonged filter regeneration phase.

In this embodiment, an additional component is preferably incorporated into the (ΔP_{MSL})_{Q} value so as to take into account the increase in pressure drop brought about by residues that cannot be burnt off during the successive regeneration cycles.

Said additional component may for example be estimated from the mileage of the vehicle and/or from prerecorded technical data.

According to the invention, the filter may further include a catalytic component and the filter may be based on silicon carbide SiC.

The invention also relates to a system for the control of an exhaust line incorporating means for implementing a method as claimed in one of the preceding claims.

The objects, aspects and advantages of the present invention will be better understood upon reading the following description of one embodiment of the invention, given by way of nonlimiting example and with reference to the appended figure. The figure illustrates a schematic view of an internal combustion engine, the exhaust line of which is fitted with a particulate filter and with means for implementing the method according to the invention.

Only the components necessary for understanding the invention have been depicted in the appended figure. The overall structure of an internal combustion engine with the reference 1 is shown, for example a diesel engine for a four-cylinder direct-fuel-injection automobile. The engine 1 is equipped with an exhaust system or line 5 that includes means 6 for filtering the emitted particulates.

Conventionally, the engine 1 is supplied with air through an intake circuit 2. One or more sensors 9 are fitted into this intake circuit for supplying an engine control computer 3 with information regarding the pressure, temperature or flow rate of the intake air.

Fuel is supplied for example by electromagnetic injectors 10 running into the combustion chambers of the engine and controlled by the computer 3 using a common-rail pressurized fuel injection circuit 4. On leaving the engine 1, the exhaust gases are discharged by the line 5 pass through a particulate filter 6. Various sensors, particularly pressure sensors 7 and temperature sensors 8, are placed upstream and downstream of the filter 5 and deliver information about the corresponding parameters to the engine control computer 3.

As known, apart from the regeneration phases, the fuel injection computer 3 therefore controls based on the information delivered by the various sensors and in particular the intake air mass and the engine speed, and also using formulae and calibrations stored in memory for the optimum setting of the engine, for the operation of the injectors and especially for the injection start time and the duration over which the injectors are open, i.e. the amount of fuel injected and therefore the richness of the mixture filling the combustion chambers.

The fuel injection computer 3 is made up in a known manner from a microprocessor or central processing unit (CPU), with the necessary random-access memories (RAMs), read-only memories (ROMs), analog/digital (A/D) converters and inlet/outlet interfaces.

As is known, the microprocessor of the fuel injection computer 3 comprises electronic circuits and appropriate software for processing the signals coming from the various sensors connected thereto, for deducing the states of the engine therefrom and for generating the appropriate control signals intended in particular for the various controlled actuators as described above. The microprocessor may also possibly control means for assisting the regeneration, for example a burner, a control system of the EGR valve type or a turbocompressor control system.

According to the invention, the computer 3 is also designed to ensure proper operation of the exhaust system and especially of the particulate filter 6. In particular, the computer 3 deduces, from the information provided in particular by the sensors 7 and 8, the regeneration phase trigger threshold and possibly regeneration phase stop threshold depending on the suitable and adaptable strategies, as will be described below. This regeneration phase essentially consists in increasing the temperature of the exhaust gases passing through the filter 6 so as to ignite the trapped particulates.

Various means for raising the temperature of the exhaust gases may be employed. This rise in temperature of the exhaust gases is for example achieved by a simple control of the injectors, by injecting, in the expansion phase, an additional amount of fuel for a given number of engine cycles.

The computer 3 is in particular suitable for implementing the calibration and control method according to the invention, as described above.

More precisely, according to the invention, a map of the average increase in pressure drop (ΔP_{MSL})_{Q} associated with the soot particles is loaded into the computer 3.

This map comprises the law of variation of the average value (ΔP_{MSL})_{Q} as a function of the flow rate Q of the exhaust gases flowing through said filter. As already described, it will be recalled that (ΔP_{MSL})_{Q} is the average pressure drop caused by the mass of soot particles present in a filter at the trigger threshold of a regeneration phase. Of course, this map of the average parameter (ΔP_{MSL})_{Q} also takes into account any necessary correction, especially due to the influence and effects of possible variations in the temperature of the gases in the exhaust line. This map was determined beforehand using any known technique, for example using a campaign of tests carried out on a population of filters of the same nature, i.e. those obtained substantially from the same initial materials and using a substantially identical manufacturing process. Preferably, said map is obtained as described above.

According to the invention, from the first time the vehicle runs, the pressure drop brought about by the on-board filter is measured at various engine speeds. For example, purely by way of illustration, the operator in charge of driving the new vehicle onto the storage yard stabilizes the engine at 1000 rpm without engaging a gear for the time necessary for the computer to obtain a first pressure drop value specific to the filter fitted into the line, corresponding to a first gas flow rate, which is for example measured by a sensor 9. The same protocol is applied for different rotation speeds of the engine, for example between 2000 and 3000 rpm.

The computer will thus recover a number of pressure drop measurements, each corresponding to one gas flow rate.

By applying a pressure drop extrapolation model, the computer obtains a map of the specific pressure drop (ΔP_{(x),soot-free})_{Q} of the filter fitted onto the exhaust line.

For example, the extrapolation model is of the quadratic type: ((ΔP_{(x),soot-free})_{Q}=aQ²+bQ+c and the coefficients a, b and c are determined by a least-squares method.

The computer then calculates, instantaneously, on the basis of the maps thus available, a new map of the pressure drop limit value (ΔP_{(x),lim})_{Q}, i.e. the threshold for triggering a regeneration phase, by applying the simple equation (ΔP_{(x),lim})_{Q}=(ΔP_{(x),soot-free})_{Q}+(ΔP_{MSL})_{Q}. According to the invention, the value thus calculated is characteristic and specific of the filter X and therefore much more precise than the predetermined trigger values of the prior art. On the basis of this new map, the computer 3 then conventionally triggers the successive regeneration phases based on the measurements obtained by the various sensors 7, 8 and 9 when this is necessary. The trigger procedures described in the applications FR 2 774 421, FR 2 829 798 or EP 587 146 may for example be used.

This in situ determination, specific to each filter, very advantageously makes it possible to qualify filters on the basis of more flexible specifications than hitherto. In particular, it becomes possible to use, without any consequence, a population of filters for which the variations, from one filter to another, in the pressure drop caused on an exhaust line, with or without soot, are relatively large, without increasing the risks of the engine deteriorating or the filter becoming damaged because of the regeneration phase being triggered too early or too late.

Furthermore, the method as described above has also the advantage of factoring out any variations due to possible inaccuracies in the measurements made in the laboratory, because of the use of a different type of sensor, for example, since the various measurements (pressure, temperature) are determined with the sensors of the vehicle incorporating the filter to be calibrated.

Without departing from the scope of the invention, the present calibration/control method may also advantageously be used in a dynamic, adaptable and prolonged manner over the lifetime of the filter and/or of the vehicle. For example, the protocol explained above may be reiterated by the computer upon a filter change. It may also be implemented at periodic intervals, for example every 10 000 kilometers, on a filter in service but one stripped of its soot, i.e. typically after a regeneration having a prolonged duration, for example twice the duration, relative to the nominal duration of a simple regeneration, so as to be certain that all of the soot has been burnt off.

However, such a use therefore preferably incorporates the re-evaluation of the term (ΔP_{MSL})_{Q}. An additional pressure drop is preferably incorporated into (ΔP_{MSL})_{Q}, which results in the increase in pressure drop brought about by the presence of accumulated residues on the filter that cannot be burnt off during the successive cycles. This additional component may for example be measured beforehand on a representative population of said filter as a function of the mass of residues in a manner similar to the method for measuring the component (ΔP_{MSL})_{Q}, for example as explained above. The mass of residues may especially also be estimated, for example according to the model of the vehicle and according to the mileage.

Other embodiments are of course possible without departing from the scope of the invention. In particular:
the method may be applied to a catalytic filter;
the method is not exclusively limited to on-vehicle combustion systems but may be used on any diesel, gasoline or other fuel static system provided that a filter regeneration process is involved.

1. A method for the calibration and control of an exhaust line of a motor vehicle that includes a particulate filter (X), said method comprising:
a) initially, on a population representative of said filter, measuring the increase in pressure drop (ΔP_{MSL})_{Q} as a function of the flow rate Q of the exhaust gases passing through said filter, (ΔP_{MSL})_{Q} being associated with a limit loading of soot particles present in a filter or a threshold for triggering a filter regeneration phase during operation of the engine;
b) measuring the specific pressure drop (ΔPhd (x),soot-free)_{Q} of said filter (X) as a function of the flow rate Q of gases passing through the filter in the absence of soot particles; and
c) determining a pressure drop limit value (ΔP_{(x),lim})_{Q} or a threshold for triggering a regeneration phase, on the basis of the values obtained from a) and b), said limit value being characteristic of said filter and obtained by the equation:
(ΔP_{(x),lim})_{Q}=(ΔP_{(x),soot-free})_{Q}+(ΔP_{MSL})_{Q}.

2. The method as claimed in claim 1, in which b) and c) are carried out on the filter (X) when the latter is fitted in the exhaust line of the vehicle.

3. The method as claimed in claim 2, in which (ΔP_{(x),soot-free})_{Q} is determined from the measured or estimated exhaust gas flow rate for each of various operating points.

4. The method as claimed in claim 3, in which the value (ΔP_{(x),soot-free})_{Q} is determined by applying a quadratic type pressure drop extrapolation model (ΔP_{(x),soot-free})_{Q}=aQ²+bQ+c, where a, b and c are coefficients that can be typically determined by a least-squares method.

5. The method as claimed in claim 2, in which b) and c) are carried out on a fresh filter.

6. The method as claimed in claim 2, in which b) and c) are carried out at regular intervals on a used but soot-free filter produced after a prolonged filter regeneration phase.

7. The method as claimed in claim 6, in which an additional component is incorporated into the (ΔP_{MSL})_{Q} value so as to take into account the increase in pressure drop brought about by residues that cannot be burnt off during the successive regeneration cycles.

8. The method as claimed in claim 7, in which said additional component is estimated from the mileage of the vehicle and/or from prerecorded technical data.

9. The method as claimed in claim 1, in which the filter further includes a catalytic component.

10. The method as claimed in claim 1, in which the filter is based on silicon carbide.

11. A system for the control of an exhaust line incorporating pressure sensors and temperature sensors that are placed upstream and downstream of the filter and are connected to the engine control computer, said computer being designed to implement a method as claimed in claim 1 and incorporating a map of the average increase in pressure drop (ΔP_{MSL})_{Q} associated with a limit soot particle loading at the threshold for triggering a regeneration phase.
